(19) United States
(12) Patent Application Publication
(10) Pub. No.: US 2020/0304831 A1
(43) Pub. Date: Sep. 24, 2020

(54) Feature Encoding Based Video Compression and Storage

(71) Applicant: GYRFALCON TECHNOLOGY INC., Milpitas, CA (US)

(72) Inventors: Lin Yang, Milpitas, CA (US); Patrick Z. Dong, San Jose, CA (US); Baohua Sun, Fremont, CA (US)

(21) Appl. No.: 16/378,565

(22) Filed: Apr. 9, 2019

Related U.S. Application Data
(60) Provisional application No. 62/822,042, filed on Mar. 21, 2019.

(51) Int. Cl. H04N 19/59; G06N 20/00; H04N 19/172; G06N 3/04

(52) U.S. Cl. CPC H04N 19/59; G06N 3/0454; H04N 19/172; G06N 20/00

(57) ABSTRACT

Methods and systems for using feature encoding for storing a video stream without redundant frames are disclosed. A video stream containing a plurality of frames is received in a computing system. Each frame is divided to one or more sub-frames with each sub-frame containing a resolution suitable as an input image to a deep learning model based on VGG-16 model, ResNet or MobilNet. Respective vectors of feature encoding values of all sub-frames of current and immediately prior frames are obtained by performing computations of the deep learning model. A difference metric between the current frame and the immediately prior frame is obtained by comparing the respective vectors using a difference measurement technique. The current frame is stored in a to-be-kept video file only when the difference metric indicates that the current frame and the immediately prior frame are different in accordance with a predefined criterion.

### CROSS-REFERENCE TO RELATED APPLICATIONS

This application claims benefits of a U. S. Provisional Patent Application Ser. No. 62/822,042 for “Feature Encoding Based Video Compression and Storage”, filed Mar. 21, 2019. The contents of which are hereby incorporated by reference in its entirety for all purposes.

### FIELD

This patent document relates generally to the field of machine learning. More particularly, the present document relates to using feature encoding for storing video stream without redundant frames.

### BACKGROUND

Machine learning is an application of artificial intelligence. In machine learning, a computer or computing device is programmed to think like human beings so that the computer may be taught to learn on its own. The development of neural networks has been key to teaching computers to think and understand the world in the way human beings do.

Many videos are stored and occupy lots of digital storage. This is even worse for videos taken by surveillance camera. The frames at a continuous time slice are pretty much the same for majority of the video stream. But these same frames are stored and taking up huge amount of storage. Even though some video compression method are introduced to address this problem, the compression rate is still not satisfying. And the disadvantage of this becomes more obvious when people are looking for something within the video stream for an abnormal behavior or event. For most of the surveillance cameras, the position is fixed, and the scene it is taking is relatively unchanged for majority of the time. It will be efficient to only store the frames with obvious scene change from its immediate prior frame. And the non-changed frames could be skipped. And then, only these frames with scene changes are saved into storage. This will save lots of digital storage resources. In addition, it will be convenient for future search for events of interest in the video stream.

### SUMMARY

This section is for the purpose of summarizing some aspects of the invention and to briefly introduce some preferred embodiments. Simplifications or omissions in this section as well as in the abstract and the title herein may be made to avoid obscuring the purpose of the section. Such simplifications or omissions are not intended to limit the scope of the invention.

Methods and systems for using feature encoding for storing a video stream without redundant frames are disclosed. According to one aspect of the disclosure, a video stream containing a plurality of frames is received in a computing system. Each frame is converted to a resolution suitable as an input image to a deep learning model based on VGG-16 model, ResNet or MobileNet. Respective vectors of feature encoding values of current and immediately prior frames are obtained by performing computations of the deep learning model. A difference metric between the current frame and the immediately prior frame is determined by comparing the respective vectors using a difference measurement technique. The current frame is stored in a to-be-kept video file only when the difference metric indicates that the current frame and the immediately prior frame are different in accordance with a predefined criterion.

According to another aspect of the disclosure, a video stream containing a plurality of frames is received in a computing system. Each frame is divided to sub-frames with each sub-frame containing a resolution suitable as an input image to a deep learning model based on VGG-16 model, ResNet or MobileNet. Respective vectors of feature encoding values of all sub-frames of current and immediately prior frames are obtained by performing computations of the deep learning model. A difference metric between the current frame and the immediately prior frame is determined by comparing the respective vectors using a difference measurement technique. The current frame is stored in a to-be-kept video file only when the difference metric indicates that the current frame and the immediately prior frame are different in accordance with a predefined criterion.

Objects, features, and advantages of the invention will become apparent upon examining the following detailed description of an embodiment thereof, taken in conjunction with the attached drawings.

### BRIEF DESCRIPTION OF THE DRAWINGS

These and other features, aspects, and advantages of the invention will be better understood with regard to the following description, appended claims, and accompanying drawings as follows:

FIG. 1A is a flowchart illustrating a first example processes of using feature encoding for storing a video stream without redundant frames in accordance with one embodiment of the invention;

FIG. 1B is a flowchart illustrating a second example processes of using feature encoding for storing a video stream without redundant frames in accordance with one embodiment of the invention;

FIG. 2 is a diagram showing an example video stream and a corresponding video output file using feature encoding in accordance with an embodiment of the invention;

FIG. 3 is a diagram showing layers of an example deep learning model based on (i.e., Visual Geometry Group (VGG-16) model) for obtaining feature encoding values of an image in accordance with an embodiment of the invention;

FIG. 4A is a diagram showing an example of converting one frame of a video stream to a resolution suitable as an input image to the deep learning model of FIG. 3 in accordance with an embodiment of the invention;

FIG. 4B is a diagram showing an example of dividing one frame of a video stream to sub-frames such that each sub-frame contains a resolution suitable as an input image to the deep learning model of FIG. 3 in accordance with an embodiment of the invention;

FIG. 5 is a schematic diagram showing an example image processing technique based on convolutional neural networks for obtaining a vector feature encoding values of an image in accordance with an embodiment of the invention;

FIG. 6 is a diagram illustrating an example two-dimensional (2-D) symbol for graphically representing respective vectors of feature encoding values of current and immediately prior frames of a video stream according to an embodiment of the invention;

FIG. 7 is a schematic diagram showing an example binary image classification of a 2-D symbol of FIG. 6 in accordance with an embodiment of the invention;

FIG. 8A is a block diagram illustrating an example Cellular Neural Networks or Cellular Nonlinear Networks (CNN) based computing system for classifying a two-dimensional symbol, according to one embodiment of the invention;

FIG. 8B is a block diagram illustrating an example CNN based integrated circuit for performing image processing based on convolutional neural networks, according to one embodiment of the invention;

FIG. 8C is a diagram showing an example CNN processing engine in a CNN based integrated circuit, according to one embodiment of the invention;

FIG. 9 is a diagram showing an example imagery data region within the example CNN processing engine of FIG. 8C, according to an embodiment of the invention;

FIGS. 10A-10C are diagrams showing three example pixel locations within the example imagery data region of FIG. 9, according to an embodiment of the invention;

FIG. 11 is a diagram illustrating an example data arrangement for performing 3×3 convolutions at a pixel location in the example CNN processing engine of FIG. 8C, according to one embodiment of the invention;

FIGS. 12A-12B are diagrams showing two example 2×2 pooling operations according to an embodiment of the invention;

FIG. 13 is a diagram illustrating a 233 2 pooling operation of an imagery data in the example CNN processing engine of FIG. 8C, according to one embodiment of the invention;

FIGS. 14A-14C are diagrams illustrating various examples of imagery data region within an input image, according to one embodiment of the invention; and

FIG. 15 is a diagram showing a plurality of CNN processing engines connected as a loop via an example clock-skew circuit in accordance of an embodiment of the invention.

### DETAILED DESCRIPTIONS

In the following description, numerous specific details are set forth in order to provide a thorough understanding of the invention. However, it will become obvious to those skilled in the art that the invention may be practiced without these specific details. The descriptions and representations herein are the common means used by those experienced or skilled in the art to most effectively convey the substance of their work to others skilled in the art. In other instances, well-known methods, procedures, and components have not been described in detail to avoid unnecessarily obscuring aspects of the invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Used herein, the terms “vertical”, “horizontal”, “diagonal”, “left”, “right”, “top”, “bottom”, “column”, “row”, “diagonally” are intended to provide relative positions for the purposes of description, and are not intended to designate an absolute frame of reference. Additionally, used herein, term “character” and “script” are used interchangeably.

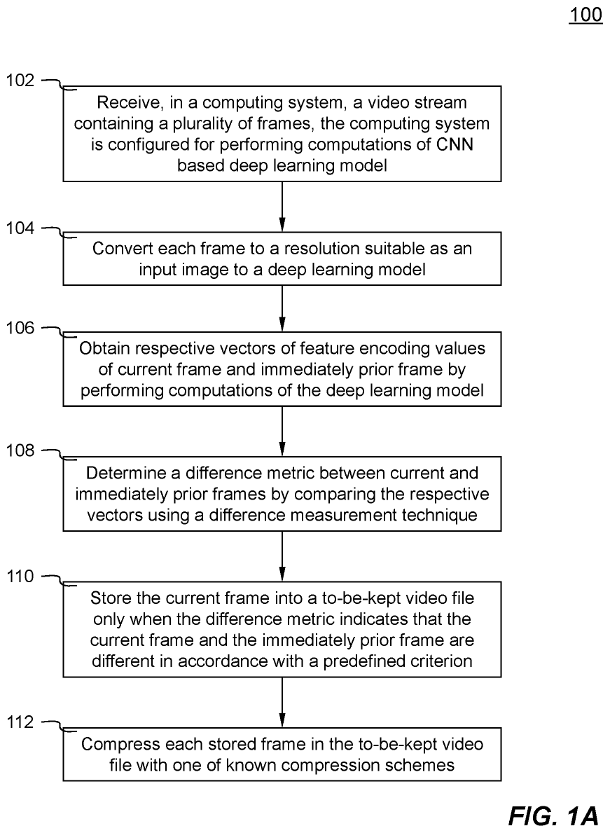

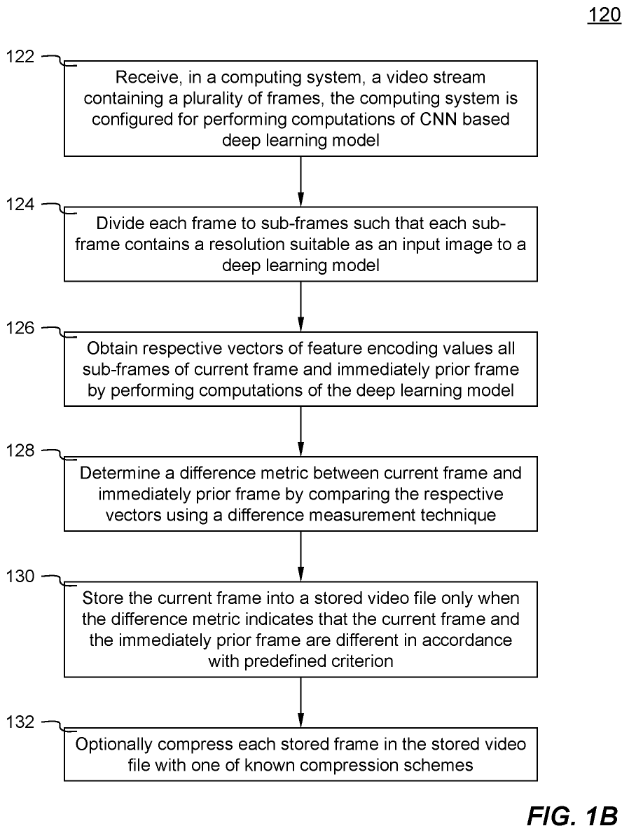

Embodiments of the invention are discussed herein with reference to FIGS. 1A-5. However, those skilled in the art will readily appreciate that the detailed description given herein with respect to these figures is for explanatory purposes as the invention extends beyond these limited embodiments.

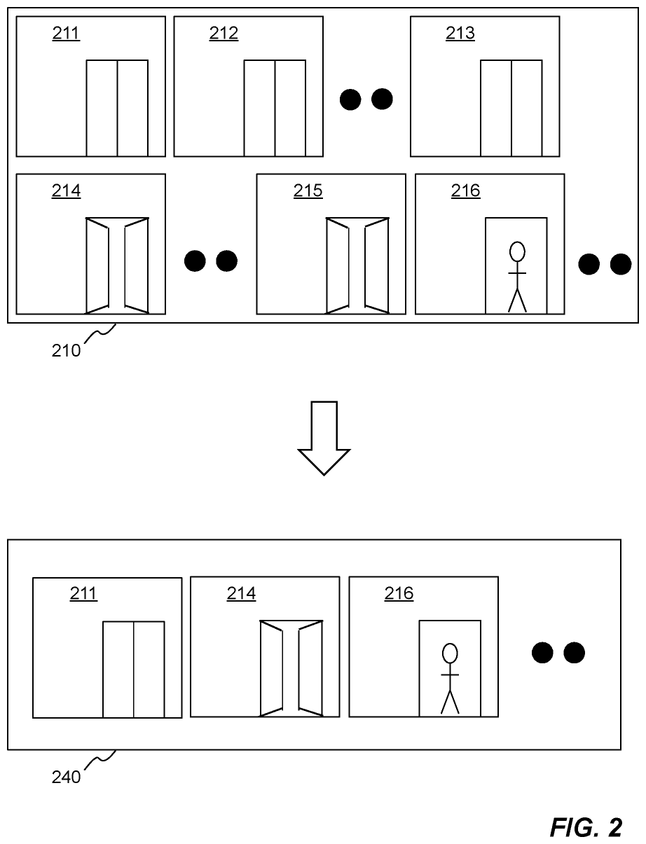

Referring first to FIG. 1A, a flowchart is illustrated for an example process 100 of using feature encoding for storing a video stream without redundant frames. Process 100 starts by receiving a video stream in a computing system at action 102. An example video stream 210 is shown in FIG. 2. The example video stream 210 contain a number of frames 211-216 (shown only few frames for illustration simplicity). To-be-kept video file 240 containing only non-redundant frames of the video stream 210 is a result of using feature encoding to determine which frame of the video stream 210 to keep in accordance with an embodiment of the invention. In the example shown in FIG. 2, frames 211-213 are the same, therefore only one copy of them (frame 211) is saved in the to-be-kept video file 240. Similarly, frames 214-215 are the same, only frame 214 is stored.

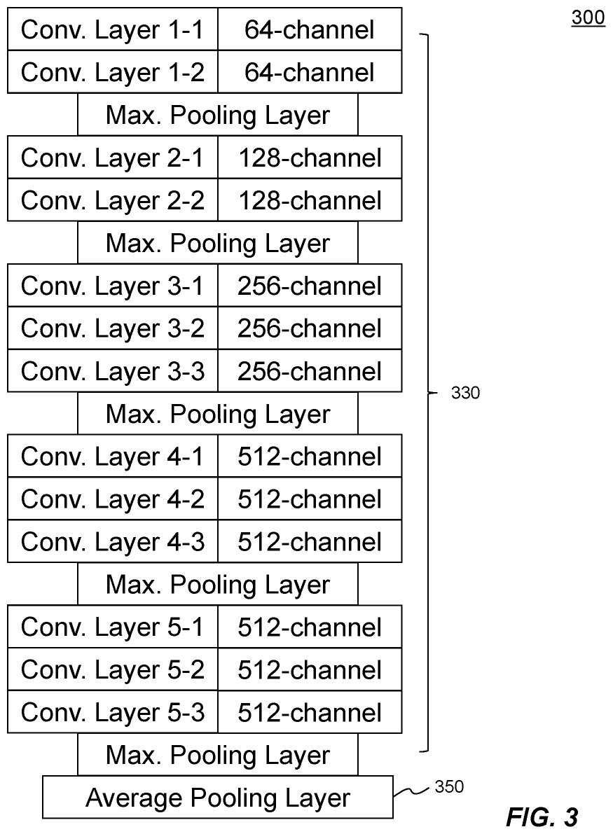

Feature encoding values are output at certain stage of a deep learning model. The layer structure of an example of the deep learning model 300 is shown in FIG. 3. In one embodiment, the deep learning model 300 is based on Visual Geometry Group VGG-16 model. As shown in FIG. 3, the 13 convolution layers and 5 max pooling layers 330 are the same as the VGG-16 model. An average pooling layer 350 is added at the end of the deep learning model 300 such that the output of this deep learning model contains a vector 512 feature encoding values, which are floating point numbers. In other words, average pooling layer 350 converts all feature encoding values to one number (i.e., average value) per channel. In another embodiment, the deep learning model 300 is based on Residual Network (ResNet). In yet another embodiment, the deep learning model 300 is based on MobileNet. One common factor is that the number of feature encoding values is a multiple of 512, for example, ResNet contains 512 feature encoding values while MobileNet contains 1024.

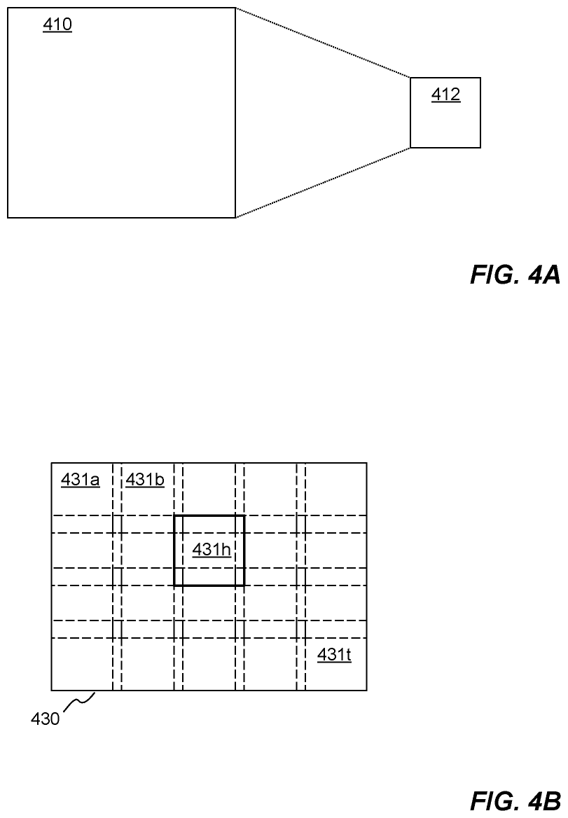

At action 104, each frame of the video stream 210 is converted to a resolution suitable as an input image to the deep learning model 300. FIG. 4A shows an example frame 410 being resized (i.e., converted) to an input image 412, which contains a resolution suitable for the deep learning model. For example, the resolution of the input image is a N×N pixels, where N is a multiple of 224.

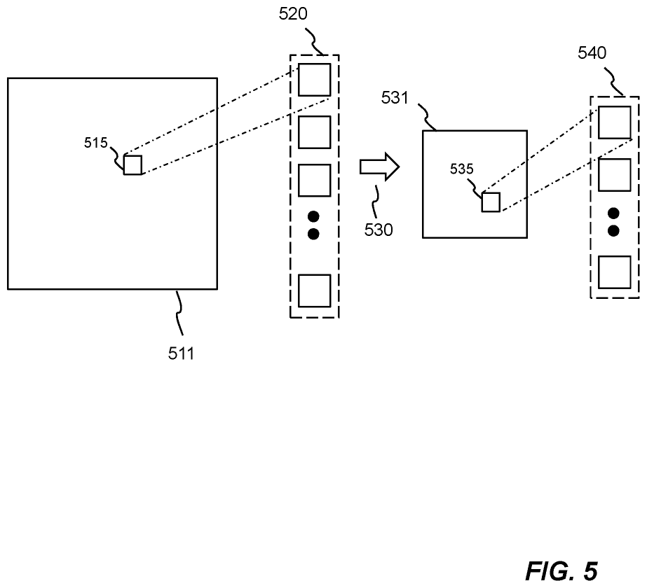

Next, at action 106, respective vectors of feature encoding values for two consecutive frames (i.e., current frame and immediately prior frame) are obtained by performing computations of the deep learning model 300. FIG. 5 shows an example image processing technique based on convolutional neural networks for obtaining a vector feature encoding values of an image.

Then a difference metric between the current frame and the immediately prior frame is determined at action 108. The difference metric is achieved by comparing the respective vectors of feature coding values using a difference measurement technique.

In one embodiment, the difference measurement technique is based on Euclidean distance between the respective vectors, each of which contains a multiple of 512 floating point numbers.

In another embodiment, the difference measurement technique is cosine similarity between the respective vectors.

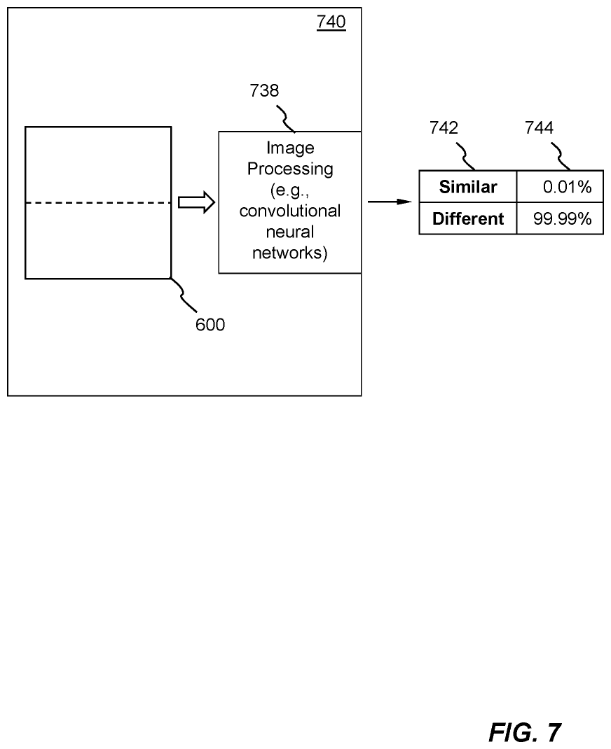

In yet another embodiment, the difference measurement technique is based on a CNN model for binary classification of “different” or “similar”. Details of binary classification are shown and described in FIG. 7 and descriptions thereof.

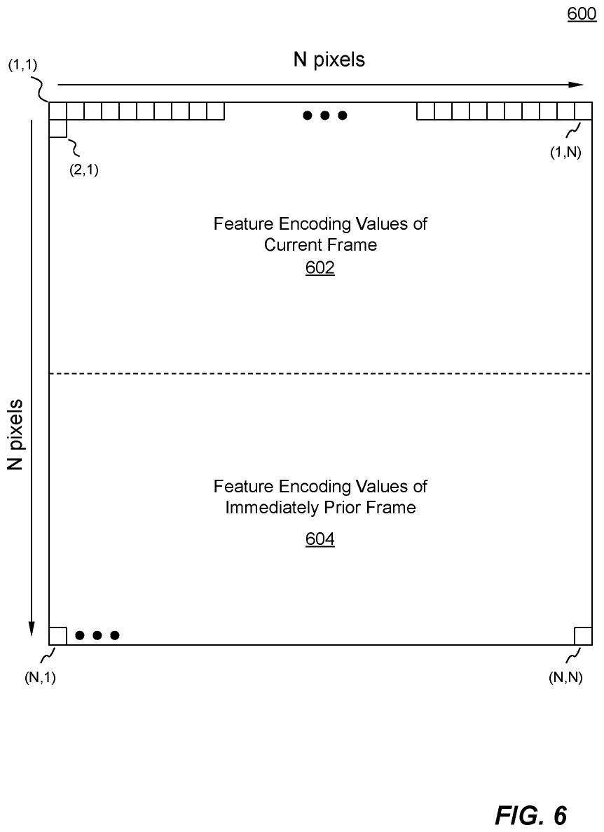

To allow binary classification for determining difference metric, respective vectors of feature encoding values are written into a two-dimensional (2-D) symbol 600 of FIG. 6. For example, a first portion 602 of the 2-D symbol is configured for representing feature encoding values of the current frame. A second portion 604 of the 2-D symbol is configured for representing feature encoding values of the immediately prior frame. The feature encoding values are quantized into intensity levels to fill into corresponding one or more pixels. For example, integers in the range of 0˜255 is used for the color intensity. The CNN model is trained such that the binary classification score at the last layer indicates whether the current frame and the immediately prior frame is different or similar.

At action 110, the current frame is saved into a to-be-kept video file (e.g., file 240 in FIG. 2B) only when the difference metric indicates that the current frame and the immediately prior frame is different in accordance with a predefined criterion (e.g., a threshold value). There are a number of ways to define the threshold value. In one embodiment, threshold value is obtained by using a labeled dataset.

Finally, at action 112, each frame of the to-be-kept video file is optionally compressed with known video compression schemes, for example, Motion Picture Experts Group MPEG-2, MPEG-4, H.264, and VC-1.

FIG. 3 is a diagram showing layers of an example deep learning model 300 based on Visual Geometry Group (VGG16) architecture neural nets used for obtaining feature encoding values of an image. In the deep learning model 300, there are 13 convolution layers, 5 max. pooling layers followed by an average pooling layer. Input imagery data is generally 224×224 pixels, which is reduced to 7×7 by P channels right before the final layer (i.e., average pooling layer). Average pooling layer further reduces the 7×7 to one value. Therefore, there are P feature encoding values for each input image at the end, where P is a multiple of 512.

FIG. 5 is a schematic diagram showing an example image processing technique based on convolutional neural networks for obtaining feature encoding values of an image. Based on convolutional neural networks, a two-dimensional symbol 511 as input image is processed with convolution operations using a first set of filters or weights 520. Since the imagery data of the 2-D symbol 511 is larger than the filters 520. Each corresponding overlapped sub-region 515 of the imagery data is processed. After the convolutional results are obtained, activation may be conducted before a first pooling operation 530. In one embodiment, activation is achieved with rectification performed in a rectified linear unit (ReLU). As a result of the first pooling operation 530, the imagery data is reduced to a reduced set of imagery data 531. For 2×2 pooling, the reduced set of imagery data is reduced by a factor of 4 from the previous set.

The previous convolution-to-pooling procedure is repeated. The reduced set of imagery data 531 is then processed with convolutions using a second set of filters 540. Similarly, each overlapped sub-region 535 is processed. Another activation can be conducted before a second pooling operation 540. The convolution-to-pooling procedures are repeated for several layers. The deep learning model 300 shown in FIG. 3 contains 13 convolution layers, 5 max pooling layers and one average pooling layers. The output at the last layer (i.e., average pooling layer) contains P feature encoding values, where P is a multiple of 512.

This repeated convolution-to-pooling procedure is trained using a known dataset or database. For image classification, the dataset contains the predefined categories. A particular set of filters, activation and pooling can be tuned and obtained before use for classifying an imagery data, for example, a specific combination of filter types, number of filters, order of filters, pooling types, and/or when to perform activation.

FIG. 6 is a diagram showing an example two-dimensional (2-D) symbol 600 for graphically representing feature encoding values of current and immediately prior frames of a video stream. The two-dimensional symbol 600 comprises a matrix of N×N pixels (i.e., N columns by N rows) of data. Pixels are ordered with row first and column second as follows: (1,1), (1,2), (1,3), . . . (1,N), (2,1), . . . , (N,1), (N,N). N is a positive integer. In one embodiment, N is equal to 224. In another embodiment, N is equal to 448. The 2-D symbol 600 is formed by partitioning into two portions (e.g., upper and lower portions as shown). The upper portion 602 is configured for representing feature encoding values of current frame, while the lower portion 604 is configured for representing feature encoding values of immediately prior frame of a video stream.

To create each portion of the 2-D symbol 600, each floating point value of the feature encoding values of a frame is converted to a corresponding color or grayscale. Depending upon number of the feature encoding values for each frame, color or grayscale is stored in one or more pixels in the 2-D symbol 600. For example, when the number of feature encoding values is 512, each feature value may occupy 49 pixels in a 224×224 2-D symbol. When the number of feature encoding values is 4608 (i.e., frame is divided to nine smaller images), each feature value may occupy 4 pixels.

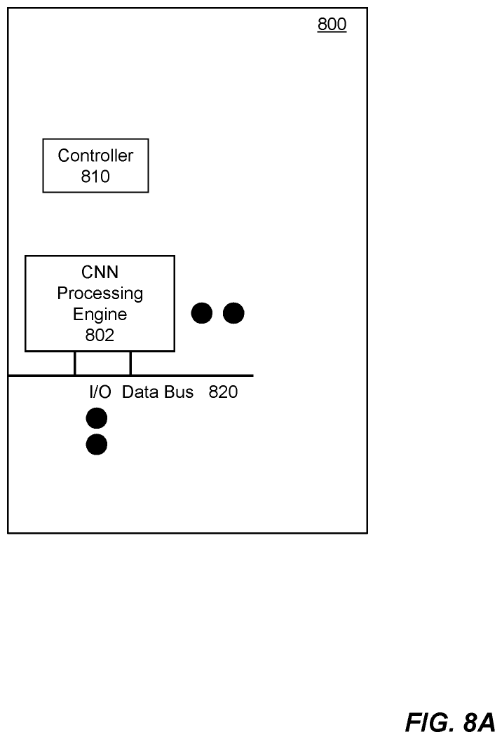

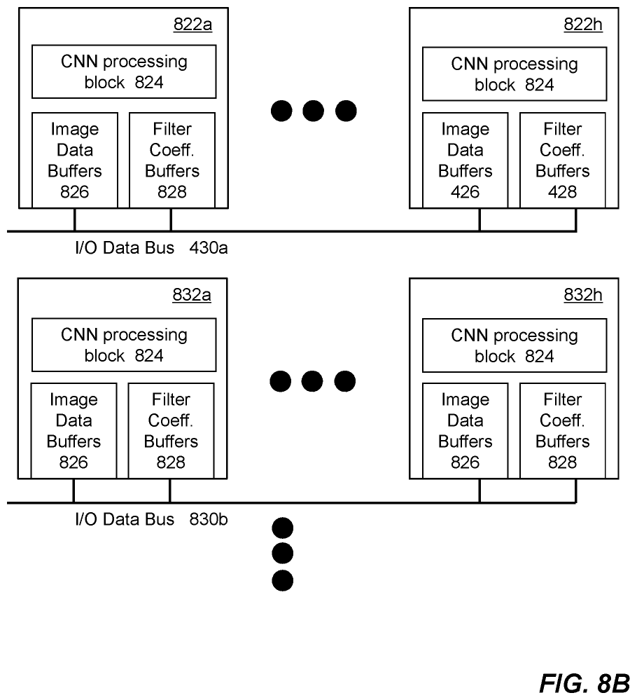

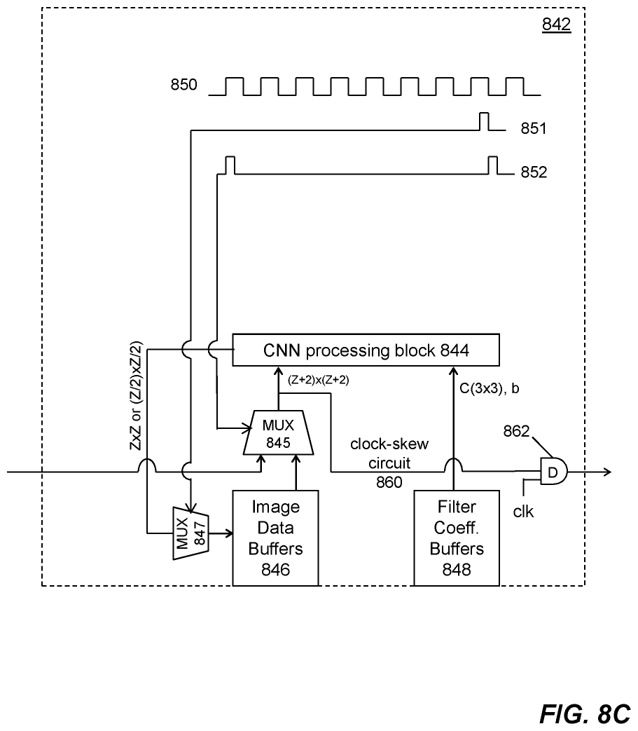

The 2-D symbol 600 is then classified in a binary classification deep learning model shown in FIG. 7. The 2-D symbol 600 is a matrix of N×N pixels of data represented color intensities. The 2-D symbol 600 is then classified in a computing system 740 (e.g., CNN based computing system 800 of FIG. 8A) by using an image processing technique 738 (i.e., a deep learning model (e.g., CNN) with pre-trained filter coefficients).

Due to huge amount of computations required in a deep learning model such as CNN, a CNN based computing system 800 is preferred.

The image processing technique 738 includes predefining two categories 742 (e.g., “Similar”, “Different”). As a result of performing the image processing technique 738, respective probabilities 744 of the categories are determined for associating one of the categories 742 “Different”. In other words, the current frame is different from the immediately prior frame according to classification result of the 2-D symbol 600 in pre-trained deep learning model.

Referring back to FIG. 1B, it is shown another example process 120 of using feature encoding for storing a video stream without redundant frames. Process 120 starts by receiving a video stream in a computing system at action 122. Then, at action 124, each frame of the received video stream is divided to a plurality of sub-frames such that each sub-frame contains a resolution of N×N pixels. N is a multiple of 224. FIG. 4B shows an example division scheme. Frame 430 of a video stream is divided to sub-frame 431a-431t. In this example, there are 20 sub-frames overlapped one another. Since each sub-frame needs to contain a resolution of N×N pixels, the division rule is to allow overlapped area up to 50% of neighboring sub-frames.

At action 126, respective vectors of feature encoding values of all sub-frames of current frame and immediately prior frame are obtained via a deep learning model, for example, the deep learning 300 based on VGG-16 model shown in FIG. 3. There are 512 feature encoding values for each sub-frame. Therefore, each vector contains concatenation of feature encoding values of all sub-frames. At action 128, difference metric is determined between the current frame and the immediately prior frame by comparing the respective vectors. Each vector contains multiple of 512 feature encoding values. For 20 sub-frames, there are 20 times 512 feature encoding values. The difference measure techniques used for determine the difference metric is the same as those used in process 100. Actions 130-132 are substantially similar to actions 110-112 of process 100. The resulting to-be-kept video file 240 contains no redundant frames. The to-be-kept video file 240 is generally located remotely from the computing system, for example, a remote storage, servers located in a cloud, etc. In another embodiment, the deep learning model is based on Residual Network (ResNet). In yet another embodiment, the deep learning model is based on MobileNet.

Referring now to FIG. 8A, it is shown a block diagram illustrating an example CNN based computing system 800 configured for classifying a two-dimensional symbol.

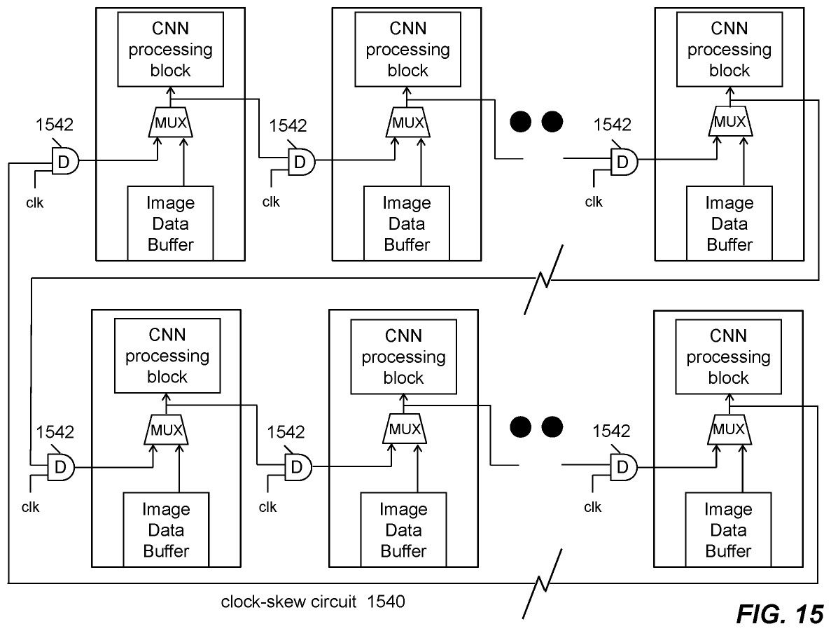

The CNN based computing system 800 may be implemented on integrated circuits as a digital semi-conductor chip (e.g., a silicon substrate in a single semi-conductor wafer) and contains a controller 810, and a plurality of CNN processing units 802a-802b operatively coupled to at least one input/output (I/O) data bus 820. Controller 810 is configured to control various operations of the CNN processing units 802a-802b, which are connected in a loop with a clock-skew circuit (e.g., clock-skew circuit 1540 in FIG. 15).

In one embodiment, each of the CNN processing units 802a-802b is configured for processing imagery data, for example, two-dimensional symbol 600 of FIG. 6.

In another embodiment, the CNN based computing system is a digital integrated circuit that can be extendable and scalable. For example, multiple copies of the digital integrated circuit may be implemented on a single semi-conductor chip as shown in FIG. 8B. In one embodiment, the single semi-conductor chip is manufactured in a single semi-conductor wafer.

All of the CNN processing engines are identical. For illustration simplicity, only few (i.e., CNN processing engines 822a-822h, 832a-832h) are shown in FIG. 8B. The invention sets no limit to the number of CNN processing engines on a digital semi-conductor chip.

Each CNN processing engine 822a-822h, 832a-832h contains a CNN processing block 824, a first set of memory buffers 826 and a second set of memory buffers 828. The first set of memory buffers 826 is configured for receiving imagery data and for supplying the already received imagery data to the CNN processing block 824. The second set of memory buffers 828 is configured for storing filter coefficients and for supplying the already received filter coefficients to the CNN processing block 824. In general, the number of CNN processing engines on a chip is 2ⁿ, where n is an integer (i.e., 0, 1, 2, 3, . . . ). As shown in FIG. 8B, CNN processing engines 822a-822h are operatively coupled to a first input/output data bus 830a while CNN processing engines 832a-832h are operatively coupled to a second input/output data bus 830b. Each input/output data bus 830a-830b is configured for independently transmitting data (i.e., imagery data and filter coefficients). In one embodiment, the first and the second sets of memory buffers comprise random access memory (RAM), which can be a combination of one or more types, for example, Magnetic Random Access Memory, Static Random Access Memory, etc. Each of the first and the second sets are logically defined. In other words, respective sizes of the first and the second sets can be reconfigured to accommodate respective amounts of imagery data and filter coefficients.

The first and the second I/O data bus 830a-830b are shown here to connect the CNN processing engines 822a-822h, 832a-832h in a sequential scheme. In another embodiment, the at least one I/O data bus may have different connection scheme to the CNN processing engines to accomplish the same purpose of parallel data input and output for improving performance.

More details of a CNN processing engine 842 in a CNN based integrated circuit are shown in FIG. 8C. A CNN processing block 844 contains digital circuitry that simultaneously obtains Z×Z convolution operations results by performing 3×3 convolutions at Z×Z pixel locations using imagery data of a (Z+2)-pixel by (Z+2)-pixel region and corresponding filter coefficients from the respective memory buffers. The (Z+2)-pixel by (Z+2)-pixel region is formed with the Z×Z pixel locations as an Z-pixel by Z-pixel central portion plus a one-pixel border surrounding the central portion. Z is a positive integer. In one embodiment, Z equals to 14 and therefore, (Z+2) equals to 16, Z×Z equals to 14×14=196, and Z/2 equals 7.

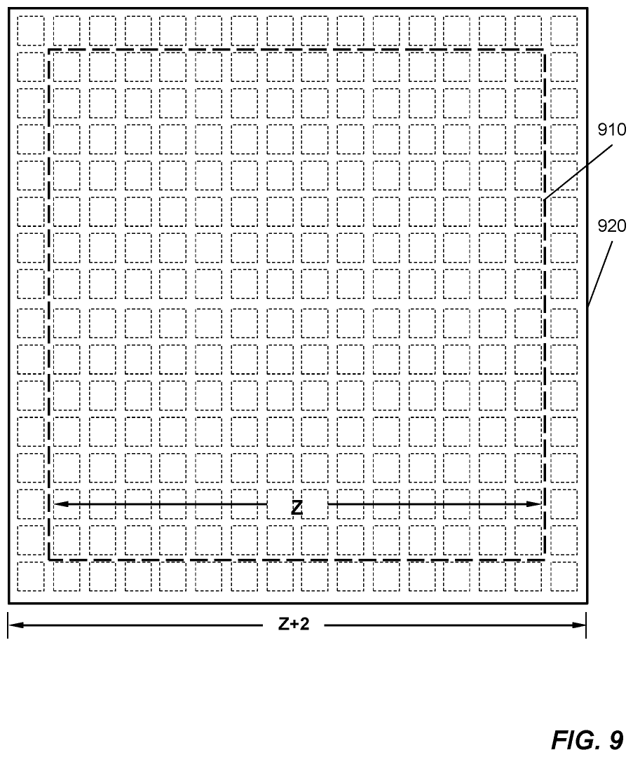

FIG. 9 is a diagram showing a diagram representing (Z+2)-pixel by (Z+2)-pixel region 910 with a central portion of Z×Z pixel locations 920 used in the CNN processing engine 842.

In order to achieve faster computations, few computational performance improvement techniques have been used and implemented in the CNN processing block 844. In one embodiment, representation of imagery data uses as few bits as practical (e.g., 5-bit representation). In another embodiment, each filter coefficient is represented as an integer with a radix point. Similarly, the integer representing the filter coefficient uses as few bits as practical (e.g., 12-bit representation). As a result, 3×3 convolutions can then be performed using fixed-point arithmetic for faster computations.

Each 3×3 convolution produces one convolution operations result, Out(m, n), based on the following formula:

$$\text{Out} ( m , n ) = {\sum }_{1 \leq i , j \leq 3} In ( m , n , i , j ) \times C ( i , j ) - b \qquad ( 1 )$$

where:
m, n are corresponding row and column numbers for identifying which imagery data (pixel) within the (Z+2)-pixel by (Z+2)-pixel region the convolution is performed;
In(m,n,i,j) is a 3-pixel by 3-pixel area centered at pixel location (m, n) within the region;
C(i, j) represents one of the nine weight coefficients C(3×3), each corresponds to one of the 3-pixel by 3-pixel area;
b represents an offset coefficient; and
j are indices of weight coefficients C(i, j).

Each CNN processing block 844 produces Z×Z convolution operations results simultaneously and, all CNN processing engines perform simultaneous operations. In one embodiment, the 3×3 weight or filter coefficients are each 12-bit while the offset or bias coefficient is 16-bit or 18-bit.

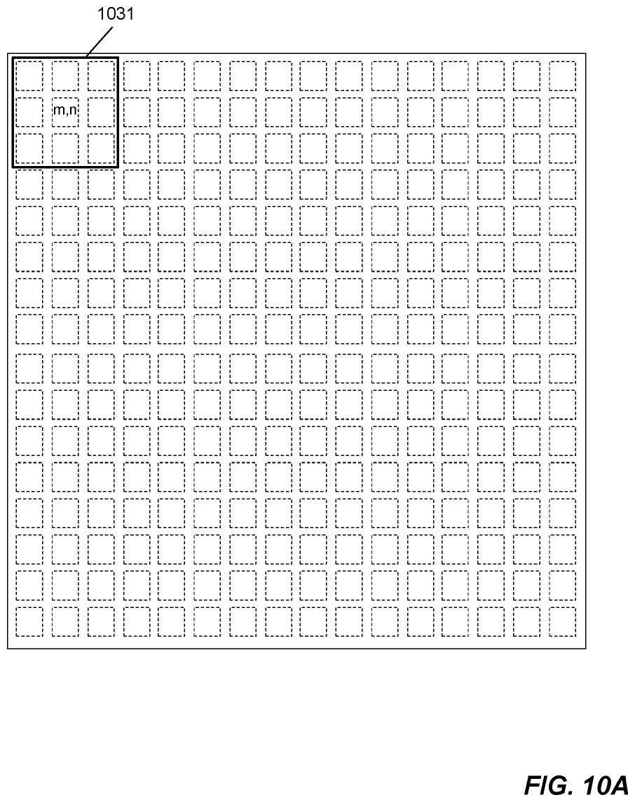

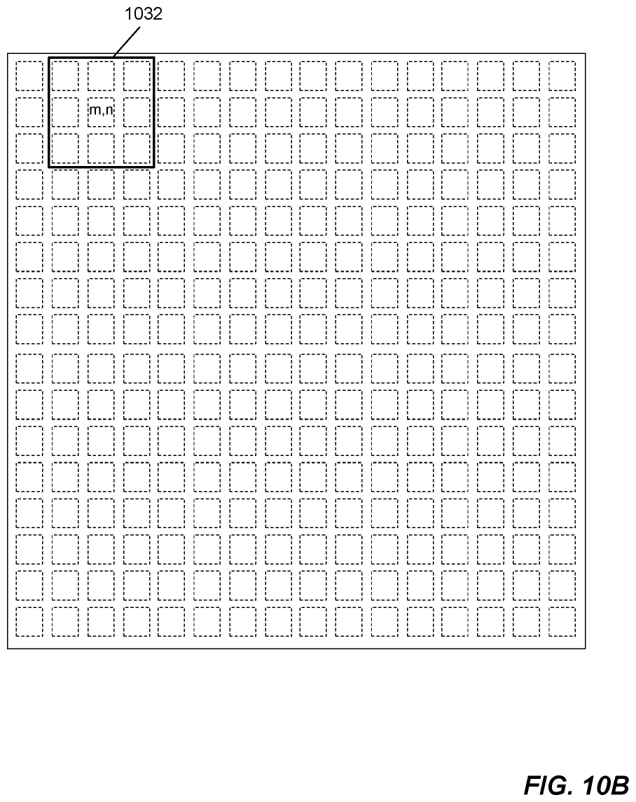

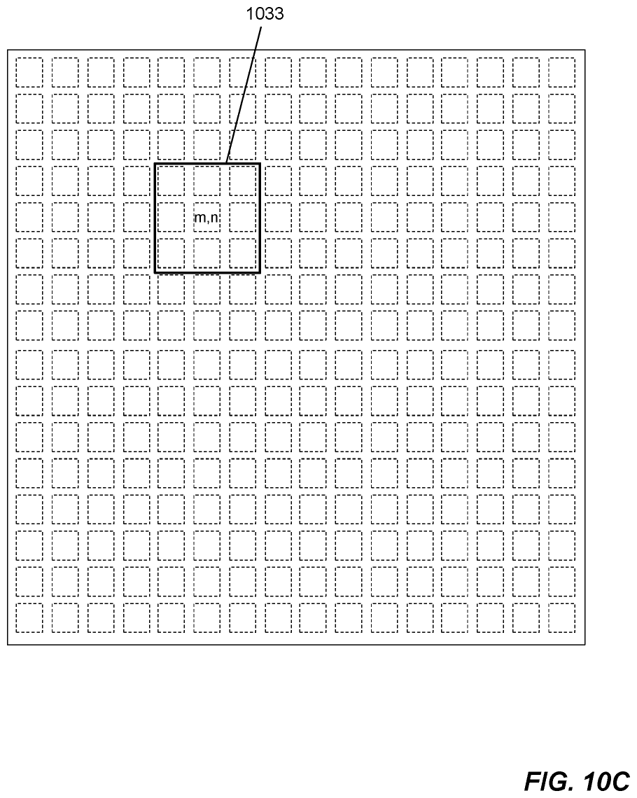

FIGS. 10A-10C show three different examples of the Z×Z pixel locations. The first pixel location 1031 shown in FIG. 10A is in the center of a 3-pixel by 3-pixel area within the (Z+2)-pixel by (Z+2)-pixel region at the upper left corner. The second pixel location 1032 shown in FIG. 10B is one pixel data shift to the right of the first pixel location 1031. The third pixel location 1033 shown in FIG. 10C is a typical example pixel location. Z×Z pixel locations contain multiple overlapping 3-pixel by 3-pixel areas within the (Z+2)-pixel by (Z+2)-pixel region.

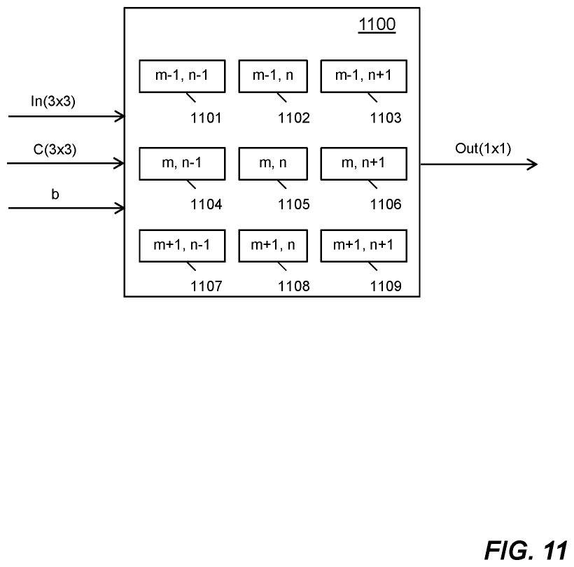

To perform 3×3 convolutions at each sampling location, an example data arrangement is shown in FIG. 11. Imagery data (i.e., In(333 3)) and filter coefficients (i.e., weight coefficients C(3×3) and an offset coefficient b) are fed into an example CNN 3×3 circuitry 1100. After 3×3 convolutions operation in accordance with Formula (1), one output result (i.e., Out(1×1)) is produced. At each sampling location, the imagery data In(3×3) is centered at pixel coordinates (m, n) 1105 with eight immediate neighbor pixels 1101-1104, 1106-1109.

Imagery data are stored in a first set of memory buffers 846, while filter coefficients are stored in a second set of memory buffers 848. Both imagery data and filter coefficients are fed to the CNN block 844 at each clock of the digital integrated circuit. Filter coefficients (i.e., C(3×3) and b) are fed into the CNN processing block 844 directly from the second set of memory buffers 848. However, imagery data are fed into the CNN processing block 844 via a multiplexer MUX 845 from the first set of memory buffers 846. Multiplexer 845 selects imagery data from the first set of memory buffers based on a clock signal (e.g., pulse 852).

Otherwise, multiplexer MUX 845 selects imagery data from a first neighbor CNN processing engine (from the left side of FIG. 8C not shown) through a clock-skew circuit 860.

At the same time, a copy of the imagery data fed into the CNN processing block 844 is sent to a second neighbor CNN processing engine (to the right side of FIG. 8C not shown) via the clock-skew circuit 860. Clock-skew circuit 860 can be achieved with known techniques (e.g., a D flip-flop 862).

After 3×3 convolutions for each group of imagery data are performed for predefined number of filter coefficients, convolution operations results Out(m, n) are sent to the first set of memory buffers via another multiplex MUX 847 based on another clock signal (e.g., pulse 851). An example clock cycle 850 is drawn for demonstrating the time relationship between pulse 851 and pulse 852. As shown pulse 851 is one clock before pulse 852, as a result, the 3×3 convolution operations results are stored into the first set of memory buffers after a particular block of imagery data has been processed by all CNN processing engines through the clock-skew circuit 860.

After the convolution operations result Out(m, n) is obtained from Formula (1), activation procedure may be performed. Any convolution operations result, Out(m, n), less than zero (i.e., negative value) is set to zero. In other words, only positive value of output results are kept. For example, positive output value 10.5 retains as 10.5 while -2.3 becomes 0. Activation causes non-linearity in the CNN based integrated circuits.

If a 2×2 pooling operation is required, the Z×Z output results are reduced to (Z/2)×(Z/2). In order to store the (Z/2)×(Z/2) output results in corresponding locations in the first set of memory buffers, additional bookkeeping techniques are required to track proper memory addresses such that four (Z/2)×(Z/2) output results can be processed in one CNN processing engine.

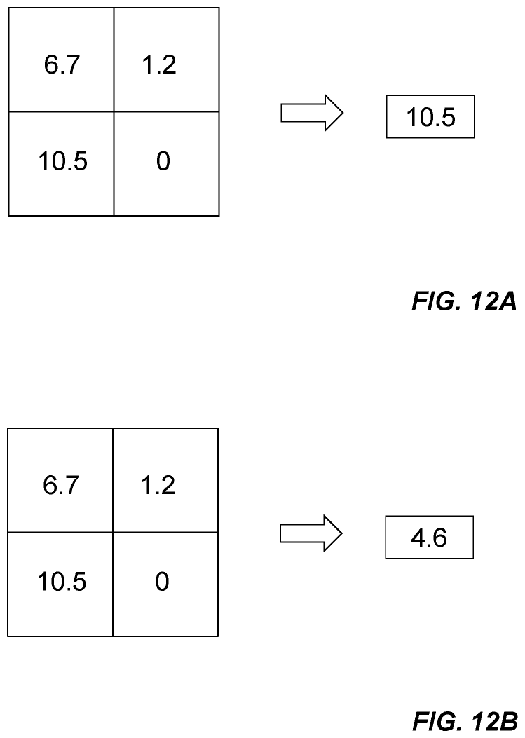

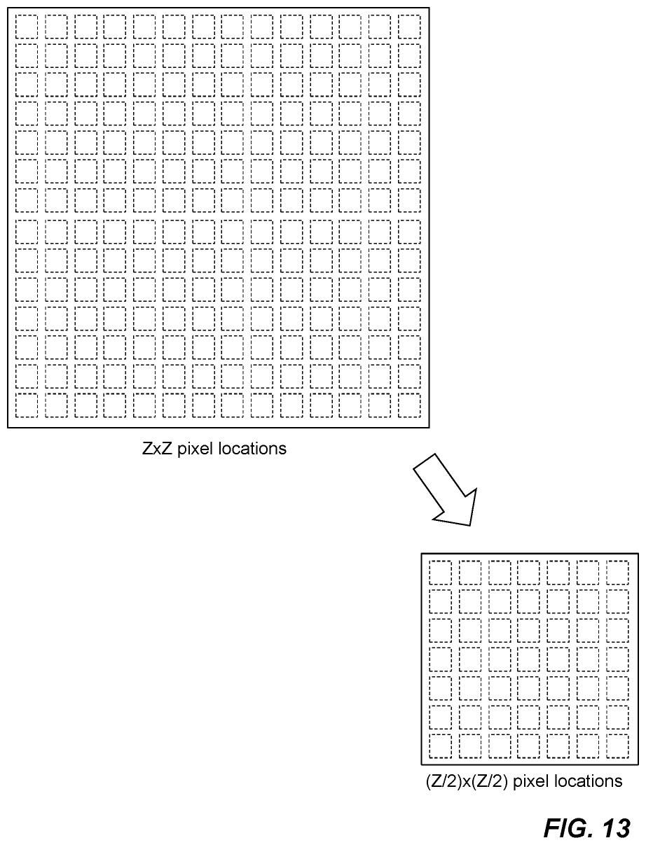

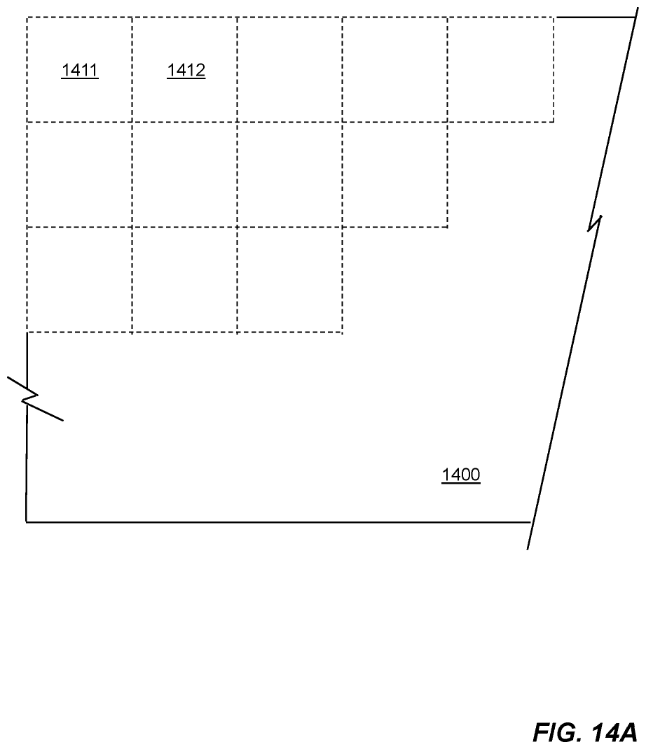

To demonstrate a 2×2 pooling operation, FIG. 12A is a diagram graphically showing first example output results of a 2-pixel by 2-pixel block being reduced to a single value 10.5, which is the largest value of the four output results. The technique shown in FIG. 12A is referred to as “max pooling”. When the average value 4.6 of the four output results is used for the single value shown in FIG. 12B, it is referred to as “average pooling”. There are other pooling operations, for example, “mixed max average pooling” which is a combination of “max pooling” and “average pooling”. The main goal of the pooling operation is to reduce size of the imagery data being processed. FIG. 13 is a diagram illustrating Z×Z pixel locations, through a 2×2 pooling operation, being reduced to (Z/2)×(Z/2) locations, which is one fourth of the original size.

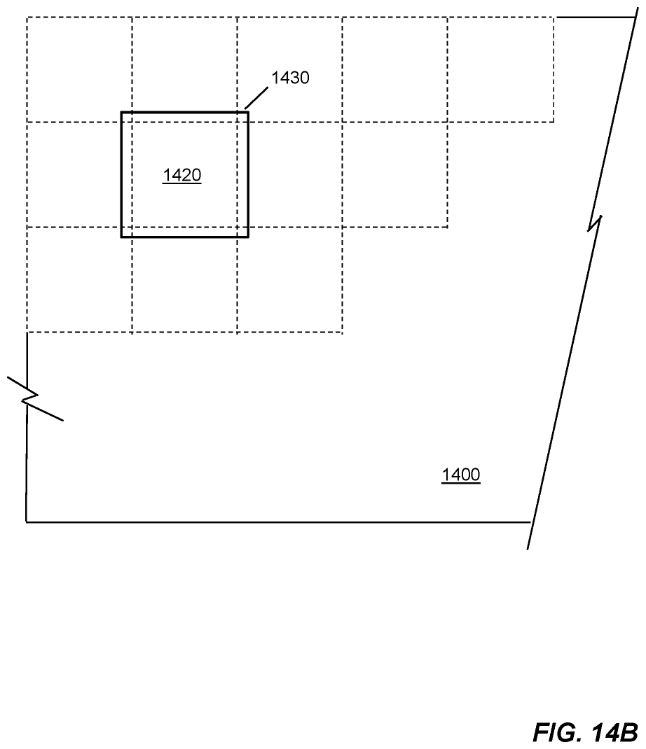

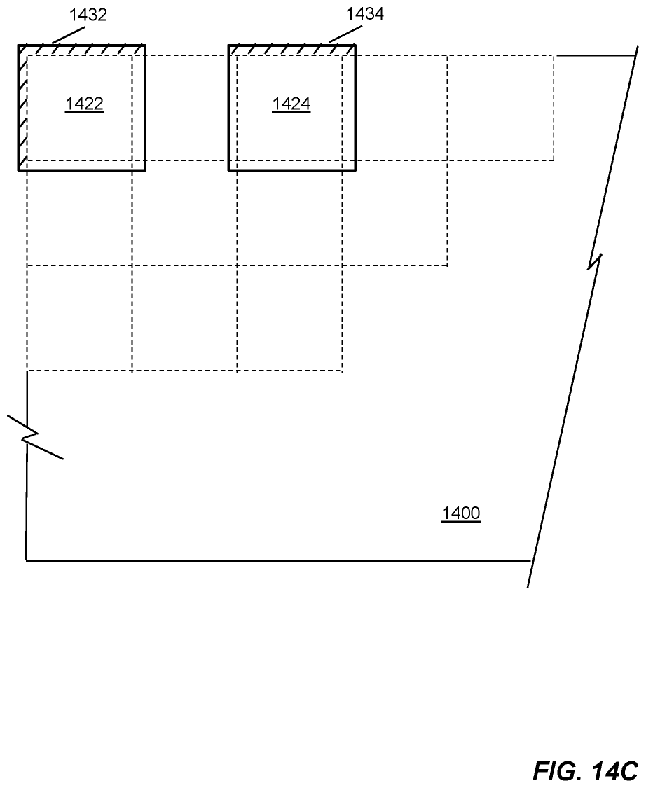

An input image generally contains a large amount of imagery data. In order to perform image processing operations, an example input image 1400 (e.g., a two-dimensional symbol 600 of FIG. 6) is partitioned into Z-pixel by Z-pixel blocks 1411-1412 as shown in FIG. 14A. Imagery data associated with each of these Z-pixel by Z-pixel blocks is then fed into respective CNN processing engines. At each of the Z×Z pixel locations in a particular Z-pixel by Z-pixel block, 3×3 convolutions are simultaneously performed in the corresponding CNN processing block.

Although the invention does not require specific characteristic dimension of an input image, the input image may be required to resize to fit into a predefined characteristic dimension for certain image processing procedures. In an embodiment, a square shape with (2^{L}×Z)-pixel by (2^{L}×Z)-pixel is required. L is a positive integer (e.g., 1, 2, 3, 4, etc.). When Z equals 14 and L equals 4, the characteristic dimension is 224. In another embodiment, the input image is a rectangular shape with dimensions of (2^{I}×Z)-pixel and (2^{J}×Z)-pixel, where I and J are positive integers.

In order to properly perform 3×3 convolutions at pixel locations around the border of a Z-pixel by Z-pixel block, additional imagery data from neighboring blocks are required. FIG. 14B shows a typical Z-pixel by Z-pixel block 1420 (bordered with dotted lines) within a (Z+2)-pixel by (Z+2)-pixel region 1430. The (Z+2)-pixel by (Z+2)-pixel region is formed by a central portion of Z-pixel by Z-pixel from the current block, and four edges (i.e., top, right, bottom and left) and four corners (i.e., top-left, top-right, bottom-right and bottom-left) from corresponding neighboring blocks.

FIG. 14C shows two example Z-pixel by Z-pixel blocks 1422-1424 and respective associated (Z+2)-pixel by (Z+2)-pixel regions 1432-1434. These two example blocks 1422-1424 are located along the perimeter of the input image. The first example Z-pixel by Z-pixel block 1422 is located at top-left corner, therefore, the first example block 1422 has neighbors for two edges and one corner. Value “0”s are used for the two edges and three corners without neighbors (shown as shaded area) in the associated (Z+2)-pixel by (Z+2)-pixel region 1432 for forming imagery data. Similarly, the associated (Z+2)-pixel by (Z+2)-pixel region 1434 of the second example block 1424 requires “0”s be used for the top edge and two top corners. Other blocks along the perimeter of the input image are treated similarly. In other words, for the purpose to perform 3×3 convolutions at each pixel of the input image, a layer of zeros (“0”s) is added outside of the perimeter of the input image. This can be achieved with many well-known techniques. For example, default values of the first set of memory buffers are set to zero. If no imagery data is filled in from the neighboring blocks, those edges and corners would contain zeros.

When more than one CNN processing engine is configured on the integrated circuit. The CNN processing engine is connected to first and second neighbor CNN processing engines via a clock-skew circuit. For illustration simplicity, only CNN processing block and memory buffers for imagery data are shown. An example clock-skew circuit 1540 for a group of example CNN processing engines are shown in FIG. 15.

CNN processing engines connected via the second example clock-skew circuit 1540 to form a loop. In other words, each CNN processing engine sends its own imagery data to a first neighbor and, at the same time, receives a second neighbor's imagery data. Clock-skew circuit 1540 can be achieved with well-known manners. For example, each CNN processing engine is connected with a D flip-flop 1542.

Although the invention has been described with reference to specific embodiments thereof, these embodiments are merely illustrative, and not restrictive of, the invention. Various modifications or changes to the specifically disclosed example embodiments will be suggested to persons skilled in the art. For example, whereas the two-dimensional symbol has been described and shown with a specific example of a matrix of 224×224 pixels, other sizes may be used for achieving substantially similar objectives of the invention, for example, 448×448, 896×896, etc. Furthermore, whereas first and second portions in a 2-D symbol have been shown and described as upper and lower portions, other partition schemes can be used for achieving the same, for example, left and right portions or any other partitions. Finally, the number of feature values has been shown and described as 512, other multiple of 512 may be used for achieving the same, for example, MobileNet contains 1024 feature encoding values. In summary, the scope of the invention should not be restricted to the specific example embodiments disclosed herein, and all modifications that are readily suggested to those of ordinary skill in the art should be included within the spirit and purview of this application and scope of the appended claims.

What is claimed is:

1. A method of using feature encoding for storing a video stream without redundant frames comprising:
receiving a video stream containing a plurality of frames in a computing system;
converting each frame to a resolution suitable as an input image to a deep learning model;
obtaining respective vectors of feature encoding values of current and immediately prior frames by performing computations of the deep learning model;
determining a difference metric between the current frame and the immediately prior frame by comparing the respective vectors using a difference measurement technique; and
storing the current frame in a to-be-kept video file only when the difference metric indicates that the current frame and the immediately prior frame are different in accordance with a predefined criterion.

2. The method of claim 1, wherein the deep learning model is based on VGG(Visual Geometry Group)-16 model that contains 13 convolution layers and 5 max pooling layers.

3. The method of claim 2, wherein the deep learning model further contains an average pooling layer.

4. The method of claim 1, wherein the deep learning model is based on Residual Network (ResNet).

5. The method of claim 1, wherein the deep learning model is based on MobileNet.

6. The method of claim 1, wherein each of the respective vectors contains P feature encoding values, where P is a multiple of 512.

7. The method of claim 1, wherein the difference measurement technique comprises calculating Euclidean distance between the respective vectors.

8. The method of claim 1, wherein the difference measurement technique comprises calculating cosine similarity between the respective vectors.

9. The method of claim 1, wherein the difference measurement technique comprises following actions:
forming a two-dimensional (2-D) symbol partitioned to first and second portions for representing the respective vectors; and
classifying the 2-D symbol using a binary image classification model to find out whether the respective vectors are different.

10. The method of claim 1, wherein the computing system comprises a Cellular Neural Networks or Cellular Nonlinear Networks (CNN) based computing system, which comprises a semi-conductor chip containing digital circuits dedicated for performing the convolutional neural networks algorithm.

11. The method of claim 1, wherein the resolution suitable as an input image comprises N×N pixels, where N is a multiple of 224.

12. A method of using feature encoding for storing a video stream without redundant frames comprising:
receiving a video stream containing a plurality of frames in a computing system;
dividing each frame to a plurality of sub-frames such that each sub-frame contains a resolution suitable as an input image to a deep learning model;
obtaining respective vectors of feature encoding values of all sub-frames of current and immediately prior frames by performing computations of the deep learning model;
determining a difference metric between the current frame and the immediately prior frame by comparing the respective vectors using a difference measurement technique; and
storing the current frame in a to-be-kept video file only when the difference metric indicates that the current frame and the immediately prior frame are different in accordance with a predefined criterion.

13. The method of claim 12, wherein the deep learning model is based on VGG (Visual Geometry Group)-16 model that contains 13 convolution layers and 5 max pooling layers.

14. The method of claim 13, wherein the deep learning model further contains an average pooling layer.

15. The method of claim 12, wherein the deep learning model is based on Residual Network (ResNet).

16. The method of claim 12, wherein the deep learning model is based on MobileNet.

17. The method of claim 12, wherein there are P feature encoding values for said each sub-frame and all feature encoding values are concatenated in the respective vectors, where P is a multiple of 512.

18. The method of claim 12, wherein the difference measurement technique comprises calculating Euclidean distance between the respective vectors.

19. The method of claim 12, wherein the difference measurement technique comprises calculating cosine similarity between the respective vectors.

20. The method of claim 12, wherein the difference measurement technique comprises following actions:
forming a two-dimensional (2-D) symbol partitioned to first and second portions for representing the respective vectors; and
classifying the 2-D symbol using a binary image classification model to find out whether the respective vectors are different.
